(19) United States
(12) Patent Application Publication
(10) Pub. No.: US 2007/0126709 A1
(43) Pub. Date: Jun. 7, 2007

(54) ELECTRONIC DEVICE HAVING SYMBOL ENTERING FUNCTION

(75) Inventors: Chin-Feng Chen, Shenzhen, Guangdong (CN); Tay-Yang Lin, Shenzhen, Guangdong (CN); Xiao-Guang Li, Shenzhen, Guangdong (CN); Te-Yao Yeh, Shenzhen, Guangdong (CN); Han-Che Wang, Shenzhen, Guangdong (CN); Kuan-Hong Hsieh, Shenzhen, Guangdong (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/563,033

(22) Filed: Nov. 24, 2006

(30) Foreign Application Priority Data
Dec. 1, 2005 (CN) 200510102123.7

(51) Int. Cl. G09G 5/00

(52) U.S. Cl. 345/173

(57) ABSTRACT

An electronic device is disclosed. The electronic device includes a processing unit, a display and a touch-sensitive apparatus. The touch-sensitive apparatus includes a plurality of touch-sensitive units. Each touch-sensitive unit is corresponding to a symbol. The processing unit receives a stroke operation on a touch-sensitive unit, and displays the corresponding symbol on the display. Entering symbols in the electronic device is convenient while avoiding dirtying or damaging the display.

### BACKGROUND

1. Technical Field

The present invention relates to an electronic device having entering function, and particularly to an electronic device having symbol entering function.

2. General Background

Nowadays, hand-held electronic devices are developed with more and more symbol input functions such as, messaging, text editing, and the like. Hand-held electronic devices are unsuitable to employ a keyboard for symbol inputs because of its compact size. A touch screen may be used in electronic devices for symbol inputs, menu selections, etc. The touch screen includes a touch-sensitive layer and a display. The touch-sensitive layer covers an area of the display. In use, a user touches the touch-sensitive layer to fulfill the input operation. However, the user's fingers have oil, dust, and even sharp fingernails that easily dirty and/or damage the display.

Therefore what is needed is an electronic device using a touch-sensitive apparatus apart from a display as symbol input apparatus.

### SUMMARY

An electronic device is disclosed. The electronic device includes a processing unit, a display and a touch-sensitive apparatus. The touch-sensitive apparatus includes a plurality of touch-sensitive units. Each touch-sensitive unit is corresponding to a symbol. The processing unit receives a stroke operation on a touch-sensitive unit, and displays the corresponding symbol on the display.

Other advantages and novel features will be drawn from the following detailed description with reference to the attached drawing, in which:

### BRIEF DESCRIPTION OF THE DRAWINGS

FIG. 1 is a schematic, front view of an electronic device according to a preferred embodiment of the present invention, the electronic device including a display and a touch-sensitive apparatus;

FIG. 2 is a block diagram representing a hardware infrastructure of a sensing signal processing circuit for a touch-sensitive unit of the touch-sensitive apparatus of FIG. 1, with the signal processing circuit electrically connecting to a processing unit; and

FIG. 3 is a schematic view showing symbol input on the electronic device of FIG. 1.

### DETAILED DESCRIPTION OF THE EMBODIMENT

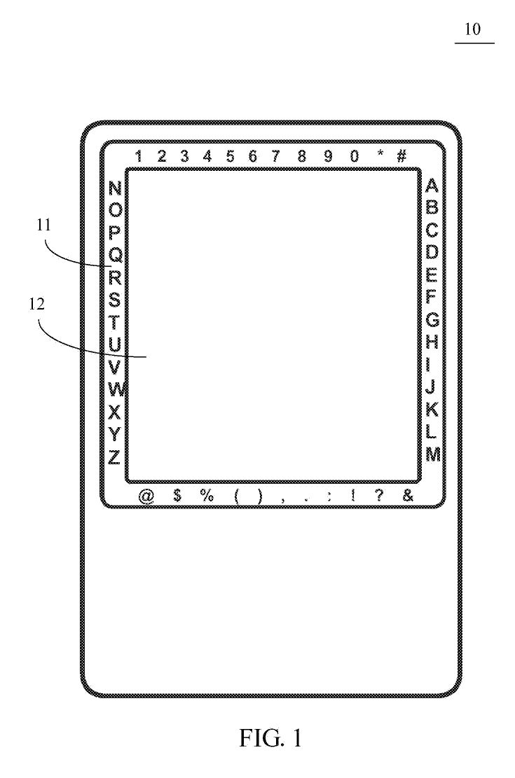

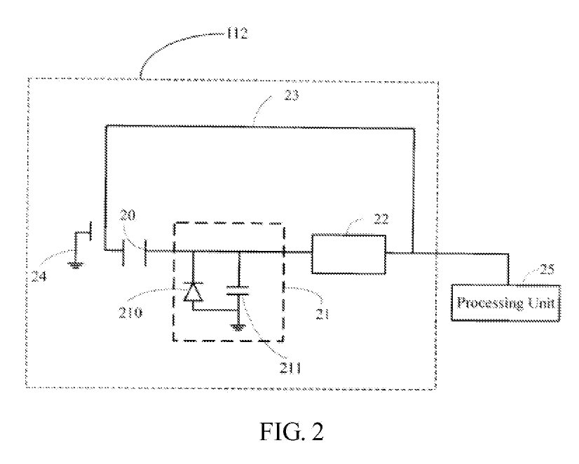

Referring to FIG. 1, an electronic device is disclosed. The electronic device 10 may be a mobile phone, a music player, a personal digital assistant, an electronic book, or any other electronic machine that requires symbol inputs. The electronic device 10 includes a display 12 and a touch-sensitive apparatus 11. The touch-sensitive apparatus 11 is disposed adjacent to the display 12, and preferably encircles a display frame of the display 12. The touch-sensitive apparatus 11 defines a plurality of icons thereon; each icon indicates a symbol. For example, in this embodiment as shown in FIG. 1, the symbols may consist of alphabet letters (e.g., ‘A’, through to ‘Z’), numbers (e.g., ‘0’, ‘1’ . . . ‘9’), punctuations (e.g., ‘,’, ‘.’, ‘:’, ‘!’, ‘?’), special symbols (e.g., ‘@’, ‘$’, ‘%’, ‘&’, ‘*’, ‘#’, ‘(’, ‘)’), and so on. The touch-sensitive apparatus 11 provides touch-sensitive units corresponding the icons for symbol inputs. Each of the touch-sensitive units further has a sensing signal processing circuit 112 as shown in FIG. 2 for generating sensing signal corresponding to the icon touched. Furthermore, each of the touch-sensitive units is assigned a coordinate for identification.

The display apparatus 10 further includes a processing unit 25 as shown in FIG. 2. Among other things, the processing unit 25 processes the sensing signals received from the touch-sensitive units of the touch-sensitive apparatus 11 according to the coordinates therewith, and performs corresponding functions. In response to the sensing signal from one of the touch-sensitive units of the touch-sensitive apparatus 11, the processing unit 25 processes the sensing signal, selects the symbol corresponding to the touch-sensitive unit and displays the symbol on the display 12 correspondingly.

Referring to FIG. 2, a block diagram of a sensing signal processing circuit 112 for the touch-sensitive unit of the touch-sensitive apparatus 11 of FIG. 1 is shown, wherein the sensing signal processing circuit 112 is in communication with the processing unit 25. The sensing signal processing circuit 112 has an antenna 20 (capacitor), a clamping circuit 21, a detector 22, a feedback line 23, and a grounding line 24. The antenna 20 is electronically coupled to an end of the clamping circuit 21, and another end of the clamping circuit is electronically coupled to an input end of the detector 22 (i.e., 20, 21, and 22 are connected in series). An output end of the detector 22 is electronically coupled to the processing unit 25 and one end of the feedback line 23. The feedback line 23 forms a positive feedback circuit with the antenna 21. The grounding line 24, which takes a form of a space between two adjacent touch-sensitive units, is for spacing the touch-sensitive units therebetween.

It is known that the human body is electrically charged with noise and static signals. Therefore, when a contact or touch is made on the touch-sensitive apparatus 11, at least some of the noise and static signals of the user along with a desired signal may be received by the antenna 20. The antenna 20 transmits the noise and static signals received to the clamping circuit 21. However, the noise and static electrical signals may cause interference to normal operations of the detector 22, and may even short circuit the detector 22 short circuit. In addition, a strong noise may adversely influence the sensing signals sent to the processing unit 25; that is, a sensitivity of the touch-sensitive unit may be diminished, and the quality of the sensing signals may be negatively impacted. Accordingly, the clamping circuit 21 is adapted for eliminating the static signals and for reducing the noise, thus improving the sensitivity of the touch-sensitive unit.

The clamping circuit 21 in one embodiment of the present invention includes a diode 210 and a capacitor 211. The cathode of the diode 210 is electronically coupled to the antenna 20, while the anode of the diode 210 is grounded. Upon receiving the noise and static signals with a desired signal, the diode 210 filters out the static signals to ground so as to avoid short-circuiting the detector 22, and reducing the noise influencing the capacitor 211. The capacitor 211 further leaks a portion of the noise reduced to ground.

The detector 22 has a high input impedance, so as to easily detect the desired signal along with the noise that has been reduced and weakened received at the input end of the detector 22. The detector 22 then converts the desired signal along with the noise that has been reduced and weakened into digital signals, namely the sensing signals, and transmits the sensing signals through the output end of the detector 22 to the processing unit 25 to perform corresponding controls. Furthermore, because the feedback line 23 forms a positive feedback circuit with the antenna 20, the noise generated as the user touches the edge of the touch-sensitive unit is filtered, thereby further improving the sensitivity accuracy of the touch-sensitive unit.

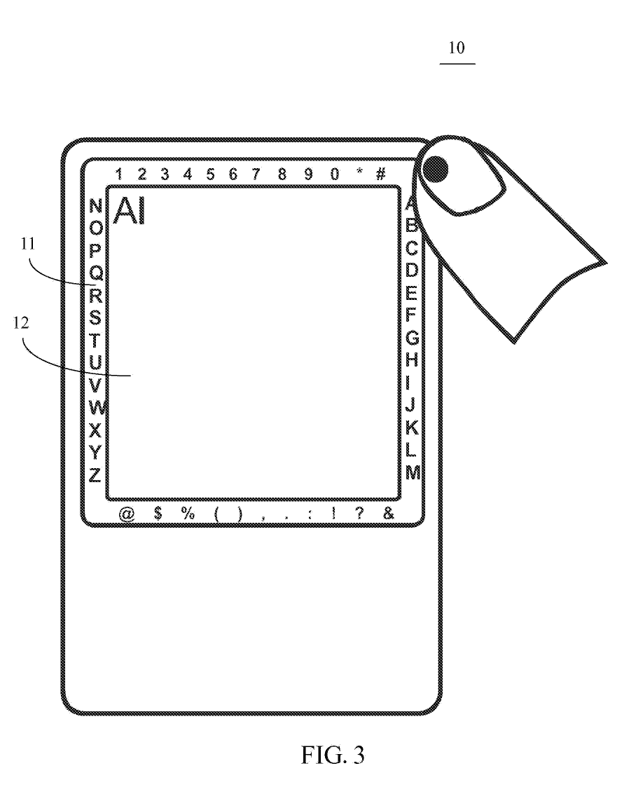

Referring to FIG. 3, in response to a touch operation on the touch-sensitive apparatus 11, a response state of the display 12 is provided. For example, as shown herein, in response to the touch operation on the icon depicted as the alphabet letter ‘A’, the corresponding sensing signal processing circuit 112 generates the sensing signal to the processing unit 25. The processing unit 25 receives and identifies the sensing signal according to the associated coordinate assigned, thereupon displays the alphabet letter ‘A’ on the display 12.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. An electronic device comprising:
a display;
a touch-sensitive apparatus, wherein the touch-sensitive apparatus includes a plurality of touch-sensitive units, each touch-sensitive unit is corresponding to a symbol; and
a processing unit for displaying a corresponding symbol on the display, in response to a touch operation on one of the touch-sensitive units.

2. The electronic device of claim 1, wherein the touch-sensitive apparatus is adjacent to the display.

3. The electronic device of claim 1, wherein the touch-sensitive apparatus includes a plurality of icons corresponding to the touch-sensitive units, each icon indicates a symbol.
